(19) United States
(12) Patent Application Publication
(10) Pub. No.: US 2021/0350486 A1
(43) Pub. Date: Nov. 11, 2021

(54) CAREER PLANNING AND PROJECT COLLABORATION SYSTEM FOR ENTERTAINMENT PROFESSIONALS

(71) Applicant: Sumukha SOMASHEKAR, Westport, CT (US)

(72) Inventor: Sumukha SOMASHEKAR, Westport, CT (US)

(21) Appl. No.: 17/271,350

(22) PCT Filed: Aug. 27, 2019
(86) PCT No.: PCT/US19/48432

§ 371 Date: Feb. 25, 2021

Related U.S. Application Data
(60) Provisional application No. 62/723,953, filed on Aug. 28, 2018.

(51) Int. Cl. G06Q 50/20; G06Q 10/10; G06Q 50/00; G06Q 10/06

(52) U.S. Cl. CPC G06Q 50/2057; G06Q 10/06393; G06Q 50/01; G06Q 10/103

(57) ABSTRACT

A career planning and project collaboration system includes a portfolio profile comprising a collections of artistic works, user characteristics, fan demographic information, and existing user accomplishments, an overall score calculator for determining an overall user score from weights assigned to the existing user accomplishments by the system, a simulated score calculator for determining a simulated score from one or more of weights assigned to selected ones of the existing user accomplishments and weights assigned to added user accomplishments, a user interface for: displaying the overall user score; displaying a list of the existing user accomplishments and providing an input for the added user accomplishments from which to select for the simulated score; displaying the simulated score for the selected actual and added user accomplishments; and allowing a user to vary the selected existing and added user accomplishments and weights to change the simulated score.

### FIELD

The disclosed exemplary embodiments are directed to system and method for providing career and project planning services, and in particular, to a career and project planning system and method that meets the needs of entertainment professionals.

### BACKGROUND

There are no tools currently available that allow various artistic professionals to effectively connect, collaborate, find work, and be found all in one place. Virtually no solutions are available to specifically help entertainment professionals effectively manage the lifecycle of their careers and projects.

Existing solutions allow professionals to submit profiles and samples of work, where producers and casting directors can search for talent and can screen casting call applicants, however, those solutions do not have the technology infrastructure in place to provide entertainment professionals with a comprehensive set of tools for career management, such as the ability to exhibit a media rich portfolio of artistic works, provide an accomplished based ranking or rating, simulate how changes in user accomplishments may impact the ranking or rating, provide an integration with social media platforms, and provide tools for collaboration among entertainment professionals.

### SUMMARY

The disclosed embodiments are directed to a system for career planning and project collaboration for entertainment professionals including a portfolio based profile, a scoring tool, an integration with social media, and a facility for collaboration with other talent.

In at least one aspect of the disclosed embodiments, a career planning and project collaboration system includes a portfolio profile comprising a collection of artistic works, a collection of user characteristics, a collection of fan demographic information, and a collection of existing user accomplishments, an overall score calculator for determining an overall user score from weights assigned to the existing user accomplishments by the system, a simulated score calculator for determining a simulated score from one or more of weights assigned to selected ones of the existing user accomplishments and weights assigned to added user accomplishments, a user interface for: displaying the overall user score; displaying a list of the existing user accomplishments and providing an input for added user accomplishments from which to select for the simulated score; displaying the simulated score for the selected actual and added user accomplishments; and allowing a user to vary the selected existing and added user accomplishments and weights assigned to the existing and added user accomplishments to change the simulated score.

The collection of artistic works may include primary artistic works created by a user and secondary artistic works created by others.

The collection of user characteristics may include a physical description of the user and a description of the user's skills.

The collection of fan demographic information may include one or more of age range, economic status, resident location type, country, and contact information for push notifications.

The collection of user accomplishments may include one or more of an educational level attained by a user, a list of educational courses completed by a user, a time between performances, a list of future performances, and data related to performance metrics.

The data related to performance metrics may include values assigned to one or more of a location, a reputation, individual reviews, ensemble reviews, recommendations, awards, event/show highlights, audience demographics, and fan engagement metrics.

The career planning and project collaboration system may further include a presentation generator for generating presentations from one or more of at least portions of works from the collection of artistic works and information from the collection of user characteristics, collection of fan demographic information, and the collection of existing user accomplishments.

The career planning and project collaboration system may include a social media integration for exchanging information with social media platforms with a push notification program triggered to send a notification based on a user determined criteria.

The social media integration may include streaming services for streaming artistic works to an audience

The career planning and project collaboration system may further include a collaboration tool for sharing and editing information among users to jointly produce artistic works.

A career planning and project collaboration system includes a computing apparatus having a processor and a memory with computer readable program code, the processor under control of the computer readable program code configured to automatically or under user control: assemble a portfolio profile comprising a collection of artistic works, a collection of user characteristics, a collection of fan demographic information, and a collection of user accomplishments; determine an overall user score from weights assigned to the existing user accomplishments by the system; and determine a simulated score from one or more of weights assigned to selected ones of the existing user accomplishments and weights assigned to added user accomplishments, wherein the computing apparatus further comprises a user interface for: displaying the overall user score; displaying a list of the existing user accomplishments and providing an input for added user accomplishments from which to select for the simulated score; displaying the simulated score for the selected actual and added user accomplishments; and allowing a user to vary the selected existing and added user accomplishments and weights assigned to the existing and added user accomplishments to change the simulated score.

The processor under control of the computer readable program code may be configured to, automatically or under user control, assemble the collection of artistic works from primary artistic works created by a user and secondary artistic works created by others.

The processor under control of the computer readable program code may be configured to, automatically or under user control, assemble the collection of user characteristics from a physical description of the user and a description of the user's skills.

The processor under control of the computer readable program code may be configured to, automatically or under user control, assemble the collection of fan demographic information from one or more of age range, economic status, resident location type, country, and contact information for push notifications.

The processor under control of the computer readable program code may be configured to, automatically or under user control, assemble the collection of user accomplishments from one or more of an educational level attained by a user, a list of educational courses completed by a user, a time between performances, a list of future performances, and data related to performance metrics.

The data related to performance metrics may include values assigned to one or more of a location, a reputation, individual reviews, ensemble reviews, recommendations, awards, event/show highlights, audience demographics, and fan engagement metrics.

The processor under control of the computer readable program code may be configured to, automatically or under user control, utilize a social media integration for exchanging information with social media platforms where the social media integration may include a push notification program triggered to send a notification based on a user determined criteria.

The social media integration may include streaming services for streaming artistic works to an audience

The processor under control of the computer readable program code may be configured to, automatically or under user control, utilize a collaboration tool for sharing and editing information among users to jointly produce artistic works.

### BRIEF DESCRIPTION OF THE DRAWINGS

FIG. 1 shows a schematic illustration of a system according to the disclosed embodiments;

FIG. 2 shows a block diagram of planning and collaboration tools included with the disclosed embodiments;

FIGS. 3A and 3B show block diagrams of a typical portfolio based profile;

FIG. 4A shows a block diagram of a scoring tool according to the disclosed embodiments;

FIG. 4B shows an exemplary procedure for calculating an overall score for a user;

FIG. 4C shows an exemplary procedure for calculating a simulated score for a user;

FIG. 5 shows a block diagram of a social media integration according to the disclosed embodiments; and

FIG. 6 shows a block diagram of a talent collaboration tool according to the disclosed embodiments.

### DETAILED DESCRIPTION

The aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

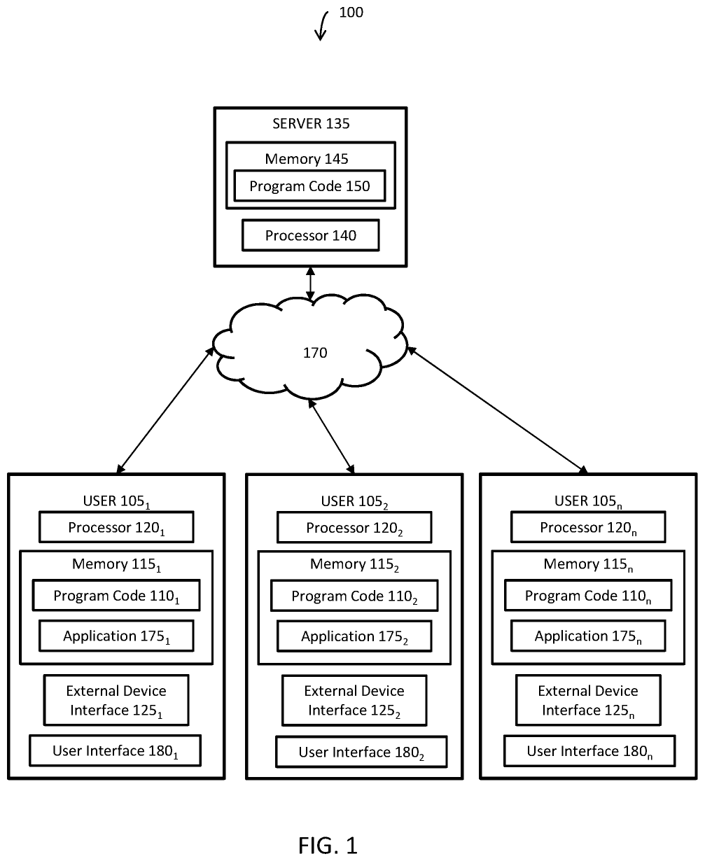

FIG. 1 shows a schematic illustration of an exemplary system 100 that provides career planning and project collaboration tools 185 according to the disclosed embodiments. One or more users may access the system 100 through user terminals 105₁-105ₙ. Users of the disclosed system may include actors, actresses, producers, production assistants, musicians, writers, dancers, photographers, fashion designers, script reviewers, and any other entertainment professionals. It should be noted that while a user may typically be an entertainment professional, it should be understood that the system may also be used for career planning and project collaboration among any suitable group of users.

The user terminals 105₁-105ₙ may operate an application 175₁-175ₙ that provides access to the career planning and project collaboration tools or, in some embodiments, the user terminals 105₁-105ₙ may provide direct access to the career planning and project collaboration tools. The user terminals 105₁-105ₙ may each include an external device interface 125₁-125ₙ that may include a web browser. The user terminals 105₁-105ₙ may each further include a user interface 180₁-180ₙ that may include one or more input and output devices, for example, a keyboard, touch screen or voice control module, and a display, virtual reality or augmented reality device.

Each user may access the career planning and project collaboration tools at anytime from anywhere through any suitable user terminal, which may include for example, a desktop computer, a laptop, a tablet, a mobile phone, or any other computing device capable of performing the functions of the disclosed embodiments. It should be understood that a user may utilize more than one computing device and more than one type of computing device to access the career planning and project collaboration tools. As another example, a user may use a mobile phone as a user terminal at one point in time to access the system and later may use a tablet as a user terminal.

Each user terminal 105₁-105ₙ may include computer readable program code 110₁-110ₙ stored on at least one non-transitory computer readable medium for carrying out and executing the processes described herein automatically or under user control. In at least one embodiment, the computer readable program code 110₁-110ₙ may invoke or operate the application 175₁-175ₙ for providing, in combination with other components of the system 100, the career planning and project collaboration tools. The computer readable medium may be memories 115₁-115ₙ, and in alternate aspects, the computer readable program code 110₁-110ₙ may be stored in memories external to, or remote from, user terminals 105₁-105ₙ. Memories 115₁-115ₙ may include magnetic media, semiconductor media, optical media, or any media which is readable and executable by a computer. Each user terminal 105₁-105ₙ may also include a processor 120₁-120ₙ for executing the computer readable program code 110₁-110ₙ. Each user terminal 105₁-105ₙ may also include at least one interface 125₁-125ₙ to external devices as mentioned above.

The career planning and project collaboration system 100 may include one or more servers 135, each with a processor 140, and memory 145 storing computer program code 150 for generally operating the server 135 to provide the planning and collaboration tools described herein. In some embodiments, the one or more servers 135 may be implemented by a cloud computing service, and the career planning and project collaboration tools may be provided in the form of software as a service (SaaS). The various components of the career planning and project collaboration system 100, including the user terminals 105₁-105ₙ and one or more servers 135, may communicate over a network 170.

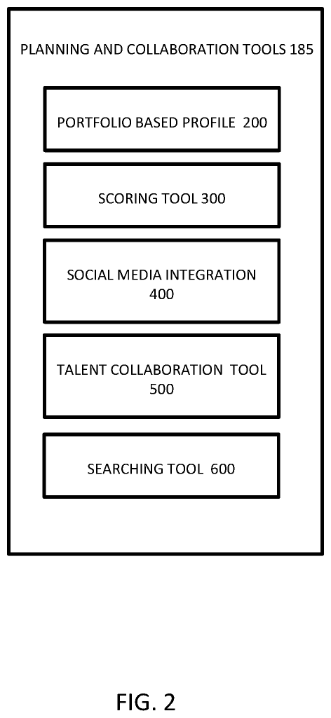

The processor 140, memory 145, and computer program code 150 may operate the server 135 to provide the planning and collaboration tools for each user automatically or under user control. As shown in FIG. 2, the planning and collaboration tools 185 may include a portfolio based profile 200, a scoring tool 300, an integration with social media 400, a facility for collaboration with other talent 500, and a searching tool 600.

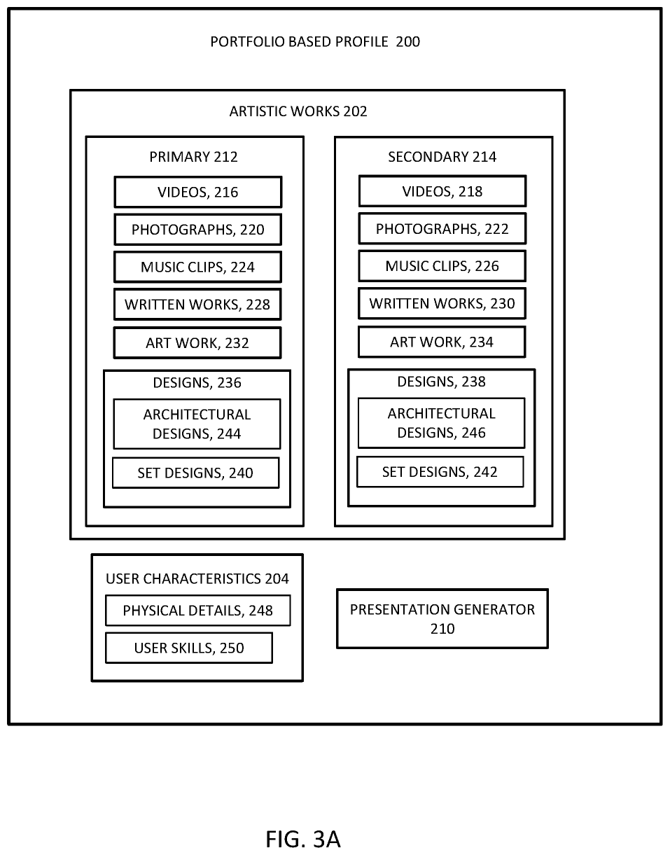

FIGS. 3A and 3B show block diagrams of a typical portfolio based profile 200. The portfolio based profile 200 for a particular user may include information organized to facilitate searching for portfolio based profiles having various selectable parameters. The information in the portfolio based profile 200 may be organized in tables, databases, or any other searchable configuration, referred to herein as collections, stored in one or more of memories 115₁-115ₙ and 145. Items in the portfolio based profile 200 may be uploaded by a user, for example, using the application 175₁-175ₙ, the external device interface 125₁-125ₙ, or the user interface 180₁-180ₙ, alone or in combination. The portfolio based profile 200 may include a collection of artistic works 202, a collection of user characteristics 204, a collection of fan demographic information 206, and a collection of user accomplishments or credits 208. Other collections of information may also be included in the portfolio based profile 200. The portfolio based profile may also include a presentation generator 210 for generating user presentations from the various collections.

The collection of artistic works 202 may include primary artistic works 212 created by a user and secondary artistic works 214 created by others. Primary artistic works 212 may be uploaded by the user or may be provided by a service, for example, a fee based service, and may be uploaded after authorization by the user. Secondary artistic works may include, for example, written works, reviews and videos, and may include works posted online. The secondary artistic works 214 may be identified via the searching tool 600 provided as part of the planning and collaboration tools 185, and may be selectively uploaded after user authorization. The secondary artistic works 214 identified by the searching tool 600 may also provide a view of internet postings related to the user.

The collection of artistic works 202 may include, for example, videos 214, 218, photographs 220, 222, music clips 224, 226, written works 228, 230, such as scripts, art work 232, 234, such as paintings, and various designs 236, 238 such as set production designs 240, 242, and architectural designs 244, 246. The collection of a user's artistic works 200 may further include any other suitable collection of artistic works.

The collection of user characteristics 204 may include various terms that may be used to describe the user. For example, the user characteristics 204 may include physical details 248 and user skills 250. User physical details may include sex, appearance and other characteristics such as height, weight, ethnicity, skin color, hair color, shoe size, etc., while user skills may include various sports, languages, accents, dance styles, musical instruments, etc., with which a user may be proficient. The user characteristics 204 may be uploaded by the user, or may be provided by the searching tool 600 provided as part of the planning and collaboration tools 185, and may be selectively uploaded after authorization by the user. The user may use the user characteristics 204 as labels for the artistic works 202 when they are posted, as evidence of the user showcasing such characteristics in the artistic works 202.

The collection of fan demographic information 206 may include general statistics such as an age range 252, economic status 254, and resident location type 256, such as urban, suburban, rural, county, city, state, and country 258 of the collection of the fans as a whole. The fan demographic information may also include fan specific information, such as when a person became a fan, a level of engagement with the user (did they click on new profile media additions, did they go to an event at which the user attended or performed, did they recommend the user to others for also being a fan, etc.) Fans may optionally provide contact information 260 for push notifications, for example using the social media integration. The fan demographic information 206 may be derived from one or more of 1) statistics pulled from social media platforms; 2) ticket sales information, in as much as can be provided by ticketing services; and 3) statistics pulled from our platform, based on actions taken by users/fans in our solution. This information can be aggregated, summarized, and presented at a high level to the user, who will have the ability to drill down into the high level report for more information and insight.

The collection of user accomplishments 208 may include, for example, an educational level attained by the user 262, a list of educational courses completed by the user 264, time between performances 266, a list of future performances 268, and data related to performance metrics 270, as well as other types of accomplishments. The data related to performance metrics may typically include values assigned to a location 272, reputation 274, individual reviews 276, ensemble reviews 278, recommendations 280, including recommendations from directors, awards 282, event/show highlights 284, audience demographics 286, and fan engagement metrics 288. The user accomplishments 208 may be uploaded by the user or may be provided by the searching tool 600 and selectively uploaded after authorization by the user. The searching tool 600 may identify items online, such as those posted on social media platforms, industry websites, venue websites, etc., including recommendations from directors, awards, event highlights, and show highlights in which the user participated.

Additional user accomplishments may include, for example, acquired roles and projects, accomplishments created by reviewers of an event (such as industry critics or newspapers), either in print or online, accomplishments (or recommendations) provided by a producer or production manager in charge of an event or production in which the user has participated. The data related to performance metrics and values for a given event/production (i.e. location, audience demographics, fan engagement, etc.) may be obtained from a venue and social media platforms used to promote the event, or may be determined by the system.

The presentation generator 210 may provide a user with the ability to generate a presentation using items extracted from the collection of artistic works 202, collection of user characteristics 204, collection of fan demographic information 206, and the collection of user accomplishments or credits 208. For example, the presentation generator 210 may provide the user with the ability to select different items, or parts of items, from the various collections and copy and paste, or otherwise assemble them together into a hardcopy or digital presentation, such as an acting resume/portfolio or demo reel.

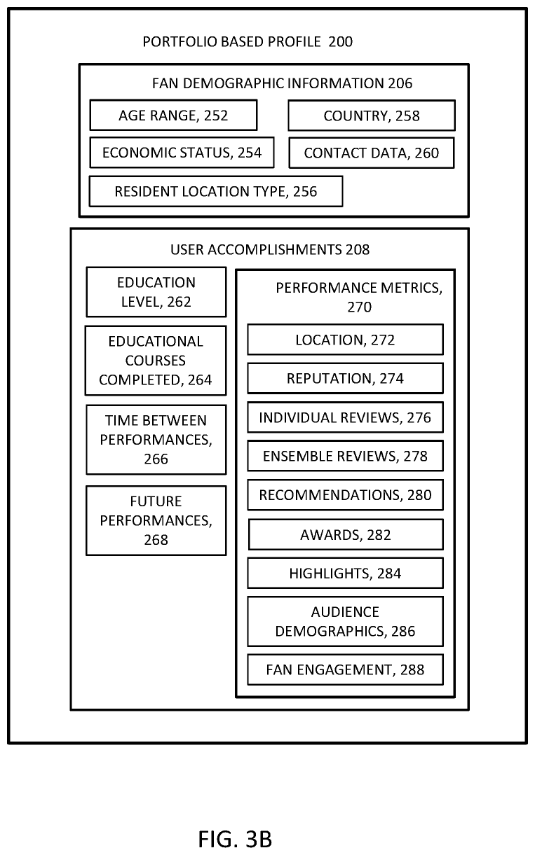

FIG. 4A shows a block diagram of the scoring tool 300. The scoring tool includes a calculator for determining an overall score 305 and a calculator for determining a simulated score 310. The overall score calculator 305 and the simulated score calculator 310 may include one or more machine learning functions 350, 355. The machine learning functions 350, 355 may utilize one or more of supervised, semi-supervised, unsupervised, and reinforcement learning techniques, and may be implemented in hardware, or may be implemented in a remote service, for example, a cloud service. In some embodiments, the overall score calculator 305 and the simulated score calculator 310 may share the same machine learning function. FIGS. 4B and 4C show block diagrams of exemplary operations of the scoring tool 300. The overall score calculator 305 may advantageously provide the ability to calculate an overall score for the user, while the simulated score calculator 310 may provide a user with the ability to vary, add, or subtract different user accomplishments and weights to demonstrate how changes in the user accomplishments and weights may influence the overall score. The overall score may represent a ranking of the user, while varying, adding, or subtracting the different user accomplishments and weights may provide the user with a simulated score that demonstrates what changes may be made to the user accomplishments and weights to improve the overall score and what changes may negatively impact the overall score.

FIG. 4B shows an exemplary procedure for calculating the overall score. As shown in block 315, the scoring tool 300 may operate to select from among existing user accomplishments 208 for use in calculating the overall score. As shown in block 320, the scoring tool 300 may assign a weight to each of the existing user accomplishments 208, and as shown in block 325, the scoring tool 300 may calculate an overall score for the user. The overall score may then be graphically displayed, for example using the external device interface 125₁-125ₙ or the user interface 180₁-180ₙ. The scoring tool 300 may utilize different weights for different accomplishments, for example, independent reviews, especially from critics, may rank higher than a user's own reviews. In some embodiments, the weights assigned to different user accomplishments may be fixed by the planning and collaboration system, while in other embodiments, the weights may be variable, for example, depending on the particular field of the entertainment professional. Some exemplary weights might include:

a volume of user mentions in online publications, and the prominence of those publications, for example, mentions in local/town articles may have less weight than state/regional articles;

a number of times a user is searched for within the planning and collaboration system;

accomplishments such as awards, positive critic reviews, fan engagement, such as from just attending events to actually sharing the event with others and writing about it online;

a trend of roles acquired, for example, receiving more prominent roles over time; and

data from prominent or influential online platforms.

FIG. 4C shows an exemplary procedure for calculating a simulated score. As shown in blocks 330 and 335, the user may optionally select user accomplishments 208, may add additional user accomplishments, or may both select and add user accomplishments for use in calculating the simulated score. As shown in blocks 340 and 345, the scoring tool 300 may assign a weight to each of the selected and added user accomplishments, the user may assign the weights to each of the selected and added user accomplishments, or the scoring tool may assign some weights while the user may assign other weights. The scoring tool 300 may then calculate the simulated score for the user as shown in block 345, at least in part by using the machine learning functions 350, 355 to analyze the collections in the users portfolio based profile 200. The machine learning functions 350, 355 may be used to perform path analysis on the data set to predict results that might result from different actions taken by the user and provide a predictive path analysis to the user. Simulating the score allows the user to vary the accomplishments and weights assigned to the accomplishments in order to understand how those variations impact the score. The simulated score may be used by a user to manipulate each accomplishment area in order to understand where a user should focus. In some embodiments the weights may be fixed by the planning and collaboration system, but a user would be informed as to how each accomplishment area affects the overall ranking. Thus, a user may be guided as to become an expert in a particular industry area, for example, become a lead actor in a particular genre or a particular time period. The planning and collaboration system may be searchable for types of particular available employment, for example, casting calls, and guide a user toward employment opportunities based on simulation scores.

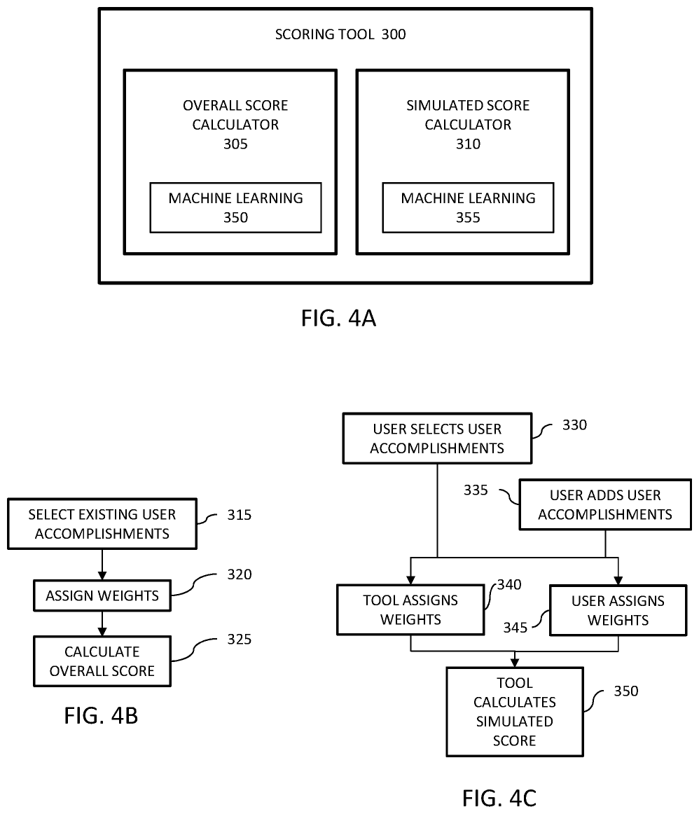

FIG. 5 shows a block diagram of an exemplary social media integration 400. The integration with social media 400 may include the ability to publish works 402 to a selected group of people, receive feedback 404 specific to the published works, filter and weight the feedback 406 based on different parameters, and advertise, promote events 408, and otherwise market the user. In at least one embodiment, the social media integration may include the ability to collect future performance information for distribution, and provide automatic updates 410 output through social media channels when the portfolio based profile 200 is updated with new artistic works 202 and new user accomplishments 208. The integration 400 may also provide a user with the ability to collect engagement information from social media platforms and synthesize for viewing by the user in their portfolio, for example, metrics such as a number of approval indications, such as “likes” provided from social media platforms, number of followers, comments, and types of comments. The information may be synthesized using sentiment analysis, demographic information of engaged fans, and fan journey information such as whether a fan attended a user's event, listen to a new portfolio post, and how long the fan engaged with the event or post. In some embodiments, the synthesized engagement information may be viewed by the user exclusively. Some embodiments may include the ability to stream artistic works and live performance feeds to an audience 412, for example, using a streaming feed or a mobile application.

The integration 400 may include push notifications 414 mentioned above to fans who opt in for such notifications, and notifications or alerts through social media platforms to publicity outlets, or other entities for promoting the entertainment professional. The notifications may be scheduled based on user determined criteria, that when met may trigger a particular notification or a group of notifications. For example, when a number of fans in the fan demographic information increases by a pre-set amount, the social media may automatically initiate an alert to a predetermined set of destinations. As another example, when tickets sales for a future performance in the user accomplishments collection 208 reach a certain level 416, an alert may be generated requesting that tickets be purchased before they are depleted. The alerts may be user designed or a user may select from a standard set of alerts provided with the integration.

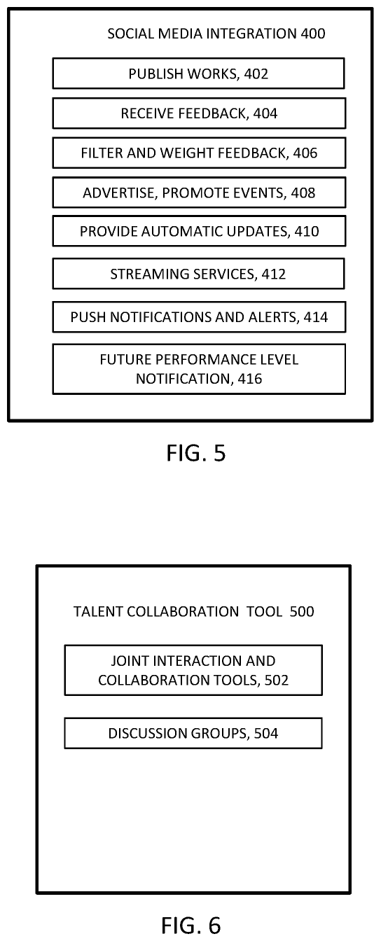

FIG. 6 shows a block diagram of an exemplary talent collaboration tool 500. The talent collaboration tool 500 provides users with a set of joint interaction and collaboration tools 502 that provide the ability to jointly produce artistic works and a set of discussion groups 504 to allow users to converse with a select community of users about specific topics. In order to jointly produce artistic works, the facility for collaboration allows users to share and edit files, video chat, and exchange written commentary. The collaboration tool 500 may include one or more controlled access file locations, where users may access, modify and store files. In some embodiments, the controlled access file locations may reside on the server, within a cloud based service, on a user terminal 105₁-105ₙ, or may be distributed across a combination of these locations. In at least one embodiment, the collaboration tool 500 may provide the ability for a number of users to interact with each other in real time, for example using a secure chat, or other communication channel, to collaborate on producing music, screenplay scripts, readings, etc. including change management capabilities. The collaboration tool 500 may also provide the ability to create discussion groups where users may discuss and share information and opinions on topics of interest. The collaboration tool 500 may be usable by any user with a suitable Internet or other network connection, and may integrate with an existing communication platform.

Various modifications and adaptations may become apparent to those skilled in the relevant arts in view of the foregoing description, when read in conjunction with the accompanying drawings. However, all such and similar modifications of the teachings of the disclosed embodiments will still fall within the scope of the disclosed embodiments.

Various features of the different embodiments described herein are interchangeable, one with the other. The various described features, as well as any known equivalents can be mixed and matched to construct additional embodiments and techniques in accordance with the principles of this disclosure.

Furthermore, some of the features of the exemplary embodiments could be used to advantage without the corresponding use of other features. As such, the foregoing description should be considered as merely illustrative of the principles of the disclosed embodiments and not in limitation thereof.

What is claimed is:

1. A career planning and project collaboration system comprising:
a portfolio profile comprising a collection of artistic works, a collection of user characteristics, a collection of fan demographic information, and a collection of existing user accomplishments;
an overall score calculator for determining an overall user score from weights assigned to the existing user accomplishments by the system;
a simulated score calculator for determining a simulated score from one or more of weights assigned to selected ones of the existing user accomplishments and weights assigned to added user accomplishments;
a user interface for:
displaying the overall user score;
displaying a list of the existing user accomplishments and providing an input for the added user accomplishments from which to select for the simulated score;
displaying the simulated score for the selected actual and added user accomplishments; and
allowing a user to vary the selected existing and added user accomplishments and weights assigned to the existing and added user accomplishments to change the simulated score.

2. The career planning and project collaboration system of claim 1, wherein the collection of artistic works comprises primary artistic works created by a user and secondary artistic works created by others.

3. The career planning and project collaboration system of claim 1, wherein the collection of user characteristics comprises a physical description of the user and a description of skills at which the user is proficient.

4. The career planning and project collaboration system of claim 1, wherein the collection of fan demographic information comprises one or more of age range, economic status, resident location type, country, and contact information for push notifications.

5. The career planning and project collaboration system of claim 1, wherein the collection of user accomplishments comprises one or more of an educational level attained by a user, a list of educational courses completed by a user, a time between performances, a list of future performances, and data related to performance metrics.

6. The career planning and project collaboration system of claim 5, wherein the data related to performance metrics comprises values assigned to one or more of a location, a reputation, individual reviews, ensemble reviews, recommendations, awards, event/show highlights, audience demographics, and fan engagement metrics.

7. The career planning and project collaboration system of claim 1, further comprising a presentation generator for generating presentations from one or more of at least portions of works from the collection of artistic works and information from the collection of user characteristics, collection of fan demographic information, and the collection of existing user accomplishments.

8. The career planning and project collaboration system of claim 1, further comprising a social media integration for exchanging information with social media platforms, wherein the social media integration comprises a push notification program triggered to send a notification based on a user determined criteria.

9. The career planning and project collaboration system of claim 8, wherein the social media integration comprises streaming services for streaming artistic works to an audience

10. The career planning and project collaboration system of claim 1, further comprising a collaboration tool for sharing and editing information among users to jointly produce artistic works.

11. A career planning and project collaboration system comprising a computing apparatus having a processor and a memory with computer readable program code, the processor under control of the computer readable program code configured to automatically or under user control:
assemble a portfolio profile comprising a collection of artistic works, a collection of user characteristics, a collection of fan demographic information, and a collection of user accomplishments;
determine an overall user score from weights assigned to the existing user accomplishments by the system; and
determine a simulated score from one or more of weights assigned to selected ones of the existing user accomplishments and weights assigned to added user accomplishments;
wherein the computing apparatus further comprises a user interface for:
displaying the overall user score;
displaying a list of the existing user accomplishments and providing an input for the added user accomplishments from which to select for the simulated score;
displaying the simulated score for the selected actual and added user accomplishments; and
allowing a user to vary the selected existing and added user accomplishments and weights assigned to the existing and added user accomplishments to change the simulated score.

12. The career planning and project collaboration system of claim 11, wherein the processor under control of the computer readable program code is configured to, automatically or under user control, assemble the collection of artistic works from primary artistic works created by a user and secondary artistic works created by others.

13. The career planning and project collaboration system of claim 11, wherein the processor under control of the computer readable program code is configured to, automatically or under user control, assemble the collection of user characteristics from a physical description of the user and a description of skills at which the user is proficient.

14. The career planning and project collaboration system of claim 11, wherein the processor under control of the computer readable program code is configured to, automatically or under user control, assemble the collection of fan demographic information from one or more of age range, economic status, resident location type, country, and contact information for push notifications.

15. The career planning and project collaboration system of claim 11, wherein the processor under control of the computer readable program code is configured to, automatically or under user control, assemble the collection of user accomplishments from one or more of an educational level attained by a user, a list of educational courses completed by a user, a time between performances, a list of future performances, and data related to performance metrics.

16. The career planning and project collaboration system of claim 15, wherein the data related to performance metrics comprises values assigned to one or more of a location, a reputation, individual reviews, ensemble reviews, recommendations, awards, event/show highlights, audience demographics, and fan engagement metrics.

17. The career planning and project collaboration system of claim 11, wherein the processor under control of the computer readable program code is configured to, automatically or under user control, generate presentations from one or more of at least portions of works from the collection of artistic works and information from the collection of user characteristics, collection of fan demographic information, and the collection of existing user accomplishments.

18. The career planning and project collaboration system of claim 11, wherein the processor under control of the computer readable program code is configured to, automatically or under user control, utilize a social media integration for exchanging information with social media platforms, wherein the social media integration comprises a push notification program triggered to send a notification based on a user determined criteria.

19. The career planning and project collaboration system of claim 18, wherein the social media integration comprises streaming services for streaming artistic works to an audience

20. The career planning and project collaboration system of claim 11, wherein the processor under control of the computer readable program code is configured to, automatically or under user control, utilize a collaboration tool for sharing and editing information among users to jointly produce artistic works.
